(19) United States
(12) Patent Application Publication
(10) Pub. No.: US 2026/0314605 A1
(43) Pub. Date: Oct. 15, 2026

(54) CONTAINER FOR BAKED PRODUCTS

(71) Applicant: Mattia PREMOLI, Casaletto Vaprio (IT)

(72) Inventor: Mattia PREMOLI, Casaletto Vaprio (IT)

(21) Appl. No.: 19/483,930

(22) PCT Filed: May 2, 2024
(86) PCT No.: PCT/IB2024/054232

§ 371 Date: Nov. 12, 2025

(30) Foreign Application Priority Data
May 16, 2023 (IT) 102023000009828

(51) Int. Cl. A21B 3/13; A21D 8/06; A23B 45/00

(52) U.S. Cl. CPC A21B 3/135; A21D 8/06; A23B 45/00

(57) ABSTRACT

A container (1) for cooking in the oven a food product (11) is provided, comprising: a vessel (2) suitable to contain at least a product (11), defining an opening (20) communicating with outside and a bottom (21) opposite to the opening (20); a cover (3) configured to be hooked to the opening (20) and to close the vessel (2); a magnetic connecting element (4) constrainable at least to the product (11) and suitable to constrain the product (11) to the container (1) by magnetic interaction; the connecting element (4) being integral to a contact surface (10) inside the container (1) and placed on one to be selected between the vessel (2) and the cover (3); the connecting element (4) is suitable to bring at least the product (11) in contact with the contact surface (10) so as to keep the product (11) in the same position with respect to the contact surface (10).

The present invention relates to a container for baked products of the type specified in the preamble of the first claim.

The object of the present invention is a container for baked products which can be applied mainly, but not exclusively, in food field and, in particular, in pastry.

Containers intended for cooking pastry products in the oven are currently known.

For some baked products such as, for example panettoni or doves, the preparation is performed by pouring the dough inside a baking cup, which is inserted inside the oven for cooking. As it is known, for these products, a stage of overturning the product after cooking is required. This stage is necessary to prevent the loss of the wished shape of the product and to keep the wished consistency of the dough.

Typically, the baked products are overturned after cooking, once extracted from the oven. The overturning stage is performed by inserting pins, hooked to a rotatable support, along the base of the baked product inside the baking cup. In the most common solutions, the pins are oriented parallelly to the ground, so as to make the product to rotate around the pin axis and to implement the overturning.

As alternative to this traditional solution another method for cooking baked products and for overturning was developed.

In particular, types of containers were implemented which act as moulds inside thereof the dough to be cooked in oven is inserted. In this case, the cooking takes place inside the mould, which is introduced inside the oven for cooking the product.

In a known solution, a baking container for preparing baked cakes comprises a cover which engages the container edge loosely before the cooking stage, but which, during cooking, engages the container edge as a consequence of the depression created inside the container during cooking. In fact, at the beginning of cooking, the gases released by the product after heating, rich in water vapour, escape from the not hermetically closed container. In the phase following cooking, one proceeds with cooling down, during which the cover closes hermetically the container as a result of the depression created after the escape of the gases contained in the product.

A peculiarity of this type of containers is that of keeping the baked product inside the container even after the closing stage, so as to prolong the shelf life of the product.

Therefore, in this type of technical solutions the presence of a shoulder around the container edge is provided, performing the function of sustaining the container during the overturing stage. These containers are typically inserted inside plates containing openings, or recesses, shaped so that the shoulder along the edge of each container could allow to hook the containers and to keep the overturned position for the whole duration of the overturning stage. In this case, in fact, there are not cores inside the mould.

The described known art comprises some important disadvantages.

In particular, for the overturning phase, the fact of arranging suitably shaped containers with respect to the resting plate results to be necessary.

Moreover, it is necessary to arrange resting plates having recesses or openings with shapes and sizes so as to allow to rest the containers. Therefore, this technical solution can require counter-shaped containers and plates, if one wants to guarantee an effective hooking.

In this situation the technical task underlying the present invention is to devise a container for baked products capable of obviating substantially at least part of the mentioned drawbacks.

Within said technical task an important object of the invention is to obtain a container for baked products which eases the procedures following the cooking of a product.

Another important object of the invention is to implement a container for baked products simplifying the equipment required to perform cooking of a baked product.

At last, an important object of the invention is to implement a container for baked products allowing long shelf life of the baked product.

The technical task and the specified objects are achieved by a container for baked products as claimed in the enclosed claim 1.

Preferred technical solutions are highlighted in the depending claims.

The features and advantages of the invention are explained hereinafter by the detailed description of preferred embodiments of the invention, with reference to the enclosed drawings, wherein:

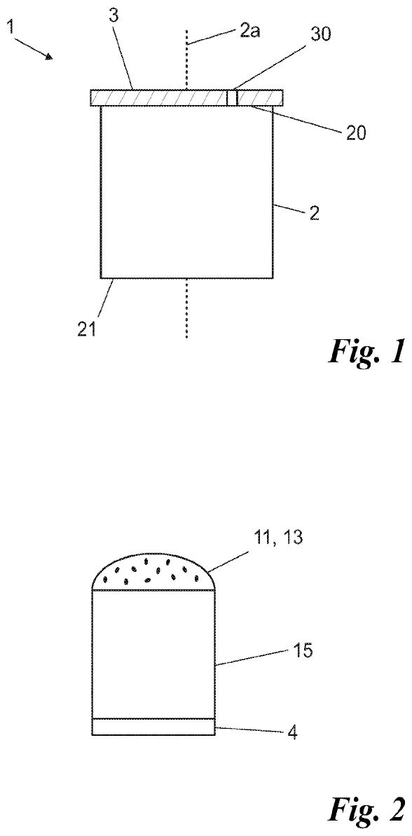

FIG. 1 shows a container for baked products according to the invention;

FIG. 2 illustrates a baked product obtainable by means of the container for baked products according to the invention;

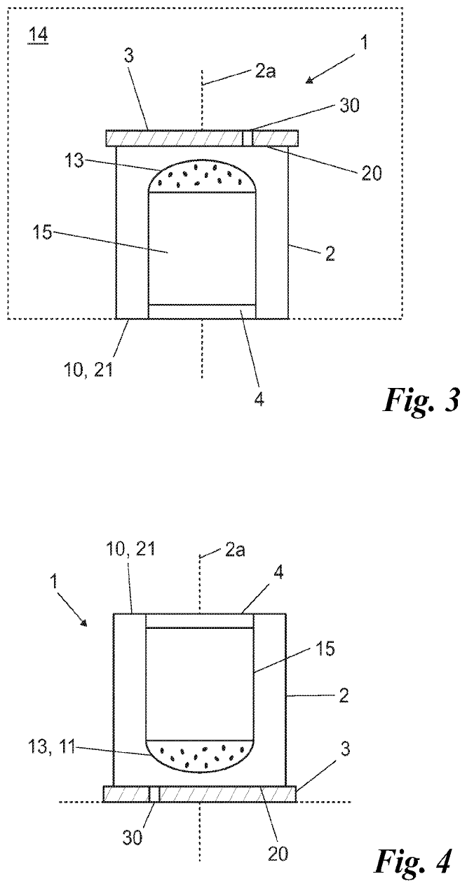

FIG. 3 illustrates the cooking in the oven of the baked product inside a container for baked products according to the invention;

FIG. 4 illustrates a phase of preparing a baked product inside a container for baked products according to the invention;

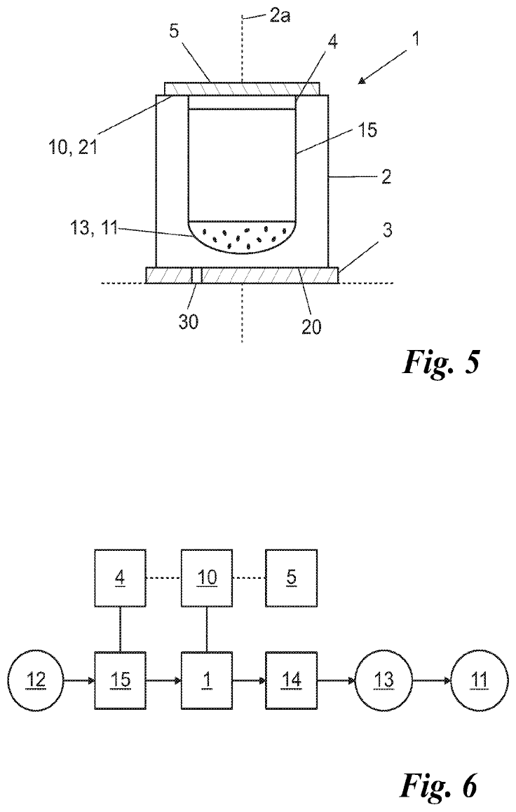

FIG. 5 illustrates an alternative of a phase of preparing a baked product inside a container for baked products according to the invention;

FIG. 6 is a scheme of a process for cooking in the oven according to the invention.

In the present document, the measurements, values, shapes and geometrical references (such as perpendicularity and parallelism), when associated to words such as “about” or other similar terms such as “approximately” or “substantially”, are to be meant as excluding measurement errors or inaccuracies due to production and/or manufacturing errors and, above all, excluding a slight deviation from the value, measurement, shape or geometrical reference thereto it is associated. For example, such terms, if associated to a value, preferably designate a deviation not higher than 10% of the value itself.

Moreover, when used, terms such as “first”, “second”, “higher”, “lower”, “main” and “secondary” do not identify necessarily an order, a relation priority or relative position, but they can be simply used to distinguish more clearly components different from each other.

Unless otherwise specified, as it results from the following discussions, it is considered that terms such as “treatment”, “computer science”, “determination”, “calculation”, or the like, relate to the action and/or processes of a computer or similar electronic calculation device which manipulates and/or transforms data represented as physical data, such as electronic quantities of registers of a computer system and/or memories into other data similarly represented as physical quantities within computer systems, registers or other devices for storing, transmitting or displaying information.

The measurements and data reported in the present text are to be considered, unless otherwise indicated, as performed under International Standard Atmosphere ICAO (ISO 2533:1975).

With reference to the Figures, the container according to the invention is designated as a whole with number 1. In particular, the container 1 is a container for baked products suitable at least to perform the cooking in the oven of a baked product 11.

The container 1 can further be suitable to preserve the product 11 following cooking. In particular, the product 11 can be a food product prepared by cooking in the oven starting form a dough such as, a panettone or a dove, or generally a product which requires a phase of cooking in the oven.

In particular, the product 11 is obtained by overturning a semi-finished product 13. The semi-finished product 13 is the product of cooking in the oven, and it is very similar to the product 11, although it is softer and prone to deform. Then, it is overturned with respect to the position in which is it during cooking, because, at the beginning of the cooling following cooking in the oven, if it is kept in the same position in which it was during cooking, the collapse of the upper portion occurs, with consequent shape loss. Then, in order to keep the wished shape, the overturning of the semi-finished product 13 is performed.

Therefore, the container 1 is advantageously suitable to be overturned by making the product 11 inside thereof not collapsing by gravity. In this way, the product 11 keeps its original shape during the phases following cooking in the oven, by avoiding then unwished alterations in the shape.

The container 1 comprises a vessel 2. The vessel 2 is suitable to contain at least the product 11. In particular, the vessel 2 is preferably suitable to contain one to be selected among a dough 12, the semi-finished product 13 and the product 11. The dough 12 can be a dough for cakes or food suitable to be cooked in oven. From it, at the end of cooking, the semi-finished product 13 is obtained.

The vessel 2 defines an opening 20 communicating with outside and a bottom 21 opposite to the opening 20. The dough 12 is inserted through the opening 20 and it is placed on the bottom 21.

The vessel 2 preferably defines an axis 2a. To this purpose, the vessel has prevailing development along the axis 2a with radial symmetry with respect to the axis 2a. The axis 2a is preferably perpendicular to the bottom 21.

The opening 20 can be circular and the axis 2a can be the axis passing through the centre of the opening 20.

Moreover, the bottom 21 is preferably flat. In this way it can be rested upon flat surfaces.

The container 1 comprises a cover 3. It is configured to be hooked to the opening 20 and to close the vessel 2.

The cover 3 can make that the closing of the container 1 is hermetic.

Alternatively, if the container 1 is closed with the cover 3 before cooking, the cover 3 can make that the closing of the vessel 2 takes place in labile way before cooking; following cooking, in fact, the gases and the water vapour contained inside the vessel 2 are removed as a result of the high temperatures, by causing a depression inside the vessel 2. The depression inside the vessel 2 makes that the cover 3 closes hermetically the vessel 2.

In a possible embodiment of the container 1, the cover 3 can be hooked to the vessel 2 by means of the opening 20, by a thread.

This solution is optimum if the container 1 acts also as packaging of the product 11. In an alternative configuration of the container 1, the cover 3 can comprise a valve 30. The valve 30 allows to expel the gases and the high pressure vapour inside the container 1 when the internal temperature rises during cooking or in the phase immediately following the closing of the container 1, in case the semi-finished product 13 is inserted hot inside the container 1 after cooking. In this way, analogously to what described previously, an internal depression is equally implemented, which allows to close hermetically the container 1 and at the same time a simpler system for closing the vessel 2 with the cover 3 is exploited, such as the hooking by thread.

The vessel 2 can comprise a material to be selected among glass, ceramic or metal.

In this way, the vessel 2 can be used even during the phase of cooking in the oven, since glass, ceramic and metal are materials resistant to the typical temperatures for cooking baked products. Moreover, the vessel 2 can be used as packaging of the product 11.

For example, the vessel 2 and the threaded cover 3 can be part of a packaging, such as jar containing the product 11.

The container 1 advantageously comprises a magnetic connecting element 4. It can be an element such as, for example, a plate or a strip. The connecting element 4 is advantageously constrainable to the product 11. It can be constrained to the dough 12 or to a baking cup 15. The baking cup 15 is a container suitable to impart to the dough 12 the wished shape and it remains adhered to the external surface of the product 11, in order to be removed before use.

The connecting element 4 then is suitable to constrain the product 11 to the container 1 by magnetic interaction. Moreover, the connecting element 4 constraints the semi-finished product 13 to the container 1, before obtaining the product 11.

The connecting element 4 makes that the semi-finished product 13 remains constrained to the vessel 2 in the wished position and does not collapse by gravity. In this way the equipment required for preparing a product 11 is advantageously simplified. In fact, the overturing is performed directly inside the container 1 and it is not necessary to use equipment dedicated to the overturning, such as, for example, rotating supports equipped with pins suitable to be inserted inside the semi-finished product 13 typically used in the production of baked products which require overturing.

In this case, in fact, a simple resting base for the container 1 is sufficient.

Moreover, the connecting element 4 is advantageously integral to a contact surface 10. It is a surface inside the container 1 and it is placed on one to be selected between the vessel 2 and the cover 3.

Therefore, the connecting element 4 is advantageously suitable to bring at least the product 11, or the semi-finished product 13, in contact with the contact surface 10. In this way the product 11, or the semi-finished product 13, is kept in the same position with respect to the contact surface 10. The connecting element 4 then performs the function of anchoring the semi-finished product 13 to the contact surface 10 and keeping the product 11 in the same position related to the container 1.

The magnetic interaction is implemented by the presence of at least a magnet.

In particular, at least one between the contact surface 10 and the connecting element 4 preferably comprises a ferrous material. Moreover, at least one between the contact surface 10 and the connecting element 4 preferably comprises a ferromagnetic material. For example, the ferromagnetic material can comprise iron, nickel or cobalt. Therefore, at least two alternative configurations are possible. In a configuration the connecting element 4 is made of ferromagnetic material and the contact surface 10 is made of ferrous material. Alternatively, the connecting element 4 can be made of ferrous material and the contact surface 10 is made of ferromagnetic material.

Generally, in both configurations the magnetic interaction between the connecting element 4 and the contact surface 10 is implemented.

Therefore, these configurations are possible when the container 1 is partially, or wholly, made of metallic material. In detail, the container 1 comprises a metallic material at least at the contact surface 10.

The container 1 preferably comprises an external support 5. It can be, for example, a plate or a pad. The external support 5 is suitable to be brought in contact with an external surface of the container 1 opposite to the contact surface 10. In detail, according to the configuration of the container 1, the external support 5 can be simply brought in contact with the external wall opposite to the contact surface 10 or it can be constrained to said external surface. In this way, the placement in positions at reduced distance on two faces of a same wall of the container 1 makes that the magnetic interaction can be however implemented. This solution is particularly advantageous if the container 1 is made of non-metallic material.

Therefore, at least one between the connecting element 4 and the external support 5 preferably comprises a ferrous material and at least one between the external support 5 and the connecting element 4 comprises a ferromagnetic material.

Therefore, in the configurations of the container 1 comprising the external support 5, the magnetic interaction can be implemented between a ferromagnetic external support 5 and a ferrous connecting element 4 or vice versa. As additional alternative, both the connecting element 4 and the external support 5 can be ferromagnetic.

These configurations have the advantage of being able to implement the magnetic interaction even in case the container 1 comprises a non-metallic material. For example, the configurations in which the container 1 comprises glass or ceramic. In particular, these configurations are advantageous in case the container 1 made of glass or ceramic material performs even the function of packaging of the product 11.

The invention comprises a new process for cooking in the oven suitable to implement the baked product 11.

The process comprises a phase of preparing the dough 12.

Subsequently, the process comprises a phase of cooking the dough 12 in an oven 14. The oven 14 can be an oven used in the industrial preparations of food.

The dough 12 is preferably positioned inside the baking cup 15 before the phase of cooking and the connecting element 4 is preferably constrained to the baking cup 15 including the dough 12. In this way, the connecting element 4 makes that the product 11, at the end of the process, is advantageously constrained to the container 1 without direct contact of the contact element 4 with the product 11.

In the phase of cooking in the oven 14, the dough 12 is preferably inserted inside the vessel 2. Then, the vessel 2 containing the dough 12 is inserted inside the oven 14 and cooking is performed. The vessel 2, during the cooking phase, can be open or closed by the cover 3.

Alternatively, the dough 12, inside the baking cup 15, can be inserted directly inside the oven 14.

Generally, inside the oven 14, during the cooking phase, the dough 12 is transformed into the semi-finished product 13.

Therefore, the subsequent phase of the process is the phase of extracting the semi-finished product 13 from the oven 14.

Subsequently, the process advantageously comprises a phase of inserting the semi-finished product 13 in the container 1. In the insertion phase the semi-finished product 13 comes in contact with the internal surface of the container 1 by means of the contact surface 10. The contact surface 10 preferably corresponds to one to be selected between the bottom 21 and the cover 3. The selection of the placement of the contact surface 10 depends upon the wished shape of the container 1. In a possible configuration, the contact surface 10 corresponds to the bottom 21.

The insertion phase does not take place if the cooking of the dough 12 takes place already inside the container 1 in the oven 14, since, at the end of cooking, the semi-finished product 13 is already present inside the container 1.

During the insertion phase, the connecting element 4 is brought in contact with the contact surface 10.

At this point, the process comprises a phase of closing the container 1. This phase is skipped if the container 1 has already been closed before cooking.

The closing of the container 1 can be performed by screwing for the embodiments in which the cover 3 comprises the thread.

The subsequent phase is the phase of overturning the container 1 and the semi-finished product 13 in order to obtain the product 11.

During the overturning phase, the container 1 containing the semi-finished product 13 is overturned so that the wall opposite to the contact surface 10 is brought in contact with the resting surface of the container 1.

The overturned semi-finished product 13 cools down and obtains the obtained consistency. Moreover, the semi-finished product 13 is overturned and hooked to the container 1 by magnetic interaction so as to remain in contact with the contact surface 10 even after overturning.

The overturning phase has the advantage of making that the semi-finished product 13 transforms into the product 11, by cooling, without alterations in the shape acquired during cooking. In this way, the product 11 keeps the wished shape once brought back into the original position.

The magnetic interaction, as already described, is due to the materials used for the connecting element and the contact surface 10.

In particular, the contact surface 10 preferably comprises a material to be selected among a ferrous material, a glassy material and a ceramic material.

If the contact surface 10 comprises a ferrous material, at least one between the connecting element 4 and the contact surface 10 preferably comprises a ferrous material and at least one between the connecting element 4 and the contact surface 10 comprises a ferromagnetic material.

If the contact surface 10 comprises a glassy material or a ceramic material, at least one between the connecting element 4 and the external support 5, placed on a surface opposite to the contact surface 10, comprises a ferrous material and at least one between the connecting element 4 and the external support 5 comprises a ferromagnetic material.

Once obtained the product 11, one can proceed with repositioning the container 1 in the original position.

At last, once repositioned the container 1, one can advantageously exploit the container 1 itself as packaging of the product 11.

Alternatively, one can proceed with opening the container 1 in order to release the product 11 and proceed with inserting the product 11 in the suitable packaging.

The container 1 according to the invention achieves important advantages.

In fact, the container 1 allows to simplify the equipment used in the process for preparing the product 11, since the overturning phase following cooking can be performed directly by overturning the container 1 in which there is the semi-finished product 13. In this way the equipment used to perform the process is simplified. In fact, differently from the known systems, in which tools are exploited suitable to inserted inside the semi-finished product 13, so as to be able to overturn it, and a support thereto the tools with the semi-finished product 13 are hooked, so as to keep it in overturned position.

Another advantage is the simplification of the phases of preparing the product 11, since the overturing phase requires the simple overturning of the container 1.

The container 1, moreover, has the advantage of being able to be used directly as packaging of the product 11, by simplifying and reducing the costs of the preparing the packaging phases.

Moreover, the container 1, if exploited for the packaging of the product 11, has the advantage of making that the shelf life of the product 11 is much longer than that deriving from the use of the packaging of known type. This makes that the container 1 could be exploited even to lengthen the shelf life of products which do not require to be overturned.

At last, the container 1 has the advantage of easing the procedures for arrangement and piling up in the warehouse.

The invention may be subject to variants within the scope of the inventive concept defined by the claims.

Within such scope, all details can be replaced by equivalent elements and the materials, shapes and sizes can be any.

1. A process for cooking in the oven suitable to implement a baked product (11) comprising:
a phase of preparing a dough (12);
a phase of cooking said dough (12) in an oven (14), wherein said dough (12) is transformed into a semi-finished product (13);
a phase of extracting said semi-finished product (13) from said oven (14); and characterized by
a phase of inserting said semi-finished product (13) in a container (1) wherein said semi-finished product (13) comes in contact with the internal surface of said container (1) by means of a contact surface (10);
a phase of closing said container (1);
a phase of overturning said container (1) and said semi-finished product (13) in order to obtain said product (11), and wherein
in said overturning phase said semi-finished product (13) is overturned and hooked to said container (1) by magnetic interaction so as to remain in contact with said contact surface (10) even after said overturning.

2. The process according to claim 1, wherein said container (1) comprises:
a vessel (2) suitable to contain one to be selected among said dough (12), said semi-finished product (13) and said product (11) and defining an opening (20) communicating with outside and a bottom (21) opposite to said opening (20);
a cover (3) configured to be hooked to said opening (20) and to close said vessel (2) and wherein there is a magnetic connecting element (4) suitable to position and keep said one to be selected between said semi-finished product (13) and said product (11) in contact with said contact surface (10) even after said overturning and to implement said magnetic interaction.

3. The process according to claim 2, wherein said contact surface (10) corresponds to one to be selected between said bottom (21) and said cover (3).

4. The process according at least to claim 2, wherein said dough (12) is positioned in a baking cup (15) before said cooking phase, and wherein said connecting element (4) is constrained to said baking cup (15) including said dough (12).

5. The process according to claim 1, wherein in said phase of cooking in said oven (14) said dough (12) is inserted inside said vessel (2), said vessel (2) containing said dough (12) is inserted inside said oven (14) and said cooking is performed.

6. The process according to claim 2, wherein said contact surface (10) comprises a material to be selected among a ferrous material, a glassy material and a ceramic material, at least one between said connecting element (4) and said contact surface (10) comprising a ferrous material and at least one between said connecting element (4) and said contact surface (10) comprising a ferromagnetic material if said contact surface (10) comprises a ferrous material or at least one between said connecting element (4) and an external support (5), placed on a surface opposite to said contact surface (10), comprising a ferrous material and at least one between said connecting element (4) and said external support (5) comprising a ferromagnetic material if said contact surface (10) comprises said glassy material or said ceramic material.

7. A container (1) for baked products suitable at least to perform the cooking in the oven of a food product (11) comprising:
a vessel (2) suitable to contain at least a product (11), defining an opening (20) communicating with outside and a bottom (21) opposite to said opening (20);
a cover (3) configured to be hooked to said opening (20) and to close said vessel (2); and characterized in that it further comprises:
a magnetic connecting element (4) constrainable at least to said product (11) and suitable to constrain said product (11) to said container (1) by magnetic interaction;
said connecting element (4) being integral to a contact surface (10) inside said container (1) and placed on one to be selected between said vessel (2) and said cover (3);
said connecting element (4) being suitable to bring at least said product (11) in contact with said contact surface (10) so as to keep said product (11) in the same position with respect to said contact surface (10).

8. The container (1) according to claim 7, wherein said vessel (2) defines an axis (2a) and said vessel (2) has prevailing development along said axis (2a) with radial symmetry with respect to said axis (2a), said axis (2a) being perpendicular to said bottom (21).

9. The container (1) according to claim 7, wherein at least one between said contact surface (10) and said connecting element (4) comprises a ferrous material and at least one between said contact surface (10) and said connecting element (4) comprises a ferromagnetic material.

10. The container (1) according to claim 7, comprising an external support (5) suitable to be brought in contact with and external surface of said container (1) opposite to said contact surface (10), wherein at least one between said connecting element (4) and said external support (5) comprises a ferrous material and wherein at least one between said external support (5) and said connecting element (4) comprises a ferromagnetic material.
